(19) United States
(12) Patent Application Publication
(10) Pub. No.: US 2024/0185267 A1
(43) Pub. Date: Jun. 6, 2024

(54) METHODS, SYSTEMS, ARTICLES OF MANUFACTURE AND APPARATUS TO DETERMINE PRODUCT CHARACTERISTICS CORRESPONDING TO PURCHASE BEHAVIOR

(71) Applicant: Nielsen Consumer LLC, Chicago, IL (US)

(72) Inventor: Michael J. Zenor, Cedar Park, TX (US)

(21) Appl. No.: 18/482,527

(22) Filed: Oct. 6, 2023

Related U.S. Application Data
(63) Continuation of application No. 17/156,220, filed on Jan. 22, 2021, now abandoned.
(60) Provisional application No. 62/965,582, filed on Jan. 24, 2020.

(51) Int. Cl. G06Q 30/0201

(52) U.S. Cl. CPC G06Q 30/0201

(57) ABSTRACT

Methods, apparatus, systems and articles of manufacture are disclosed to generate characteristic metrics. An example apparatus includes a characteristics identifier to identify characteristics corresponding to purchase data, a characteristic selector to select one of the characteristics, a likelihood calculator to calculate a likelihood value of a first level of the selected one of the characteristics, and an importance metric calculator to reduce discretionary input of an analyst by calculating an importance metric based on a ratio of (a) the likelihood value of the first level and (b) a maximum likelihood value corresponding to the first level of the selected one of the characteristics.

### RELATED APPLICATION

This patent arises from a continuation of U.S. patent application Ser. No. 17/156,220 (now U.S. Pat. No. ______), filed on Jan. 22, 2021, which claims the benefit of U.S. Provisional Patent Application Ser. No. 62/965,582, which was filed on Jan. 24, 2020. U.S. patent application Ser. No. 17/156,220 and U.S. Provisional Patent Application Ser. No. 62/965,582 are hereby incorporated herein by reference in their entireties. Priority to U.S. patent application Ser. No. 17/156,220 and U.S. Provisional Patent Application Ser. No. 62/965,582 is hereby claimed.

### FIELD OF THE DISCLOSURE

This disclosure relates generally to the technical field of market research, and, more particularly, to methods, systems, articles of manufacture and apparatus to determine product characteristics corresponding to purchase behavior.

### BACKGROUND

In recent years, market analysts, product manufacturers, retailers and/or any number of entities associated with product marketing have sought insight into how to improve sales of products and/or services. Such efforts invoke technological resources associated with data acquisition, data cleansing, storage, and data processing. Data processing efforts in this technical field of market research include computational hardware resources such as server farms and/or cloud resources, and also include computational processing technologies to manage large and/or otherwise unmanaged data sources, such as machine learning algorithms.

### BRIEF DESCRIPTION OF THE DRAWINGS

FIG. 1 is a schematic illustration of an example characteristics analysis system, which includes an example characteristics metric calculator constructed in accordance with teachings of this disclosure to determine product characteristics corresponding to purchase behavior.

FIG. 2 is a diagram representative of example household purchase data corresponding to binomial characteristics.

FIG. 3 is a diagram representative of example household purchase data corresponding to multinomial characteristics.

FIGS. 4-6 are flowcharts representative of example machine readable instructions that may be executed to implement the example system of FIG. 1 to determine product characteristics corresponding to purchase behavior.

FIG. 7 is a block diagram of an example processing platform structured to execute the instructions of FIGS. 4-6 to implement the example system of FIG. 1 to determine product characteristics corresponding to purchase behavior.

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Market analysts, researchers, retailers, product manufacturers and/or other entities associated with product and/or service sales (hereinafter referred to herein generally as market analysts) strive to maintain and/or otherwise improve sales performance. Such market analysts have control over one or more aspects of the success of marketing efforts, such as advertising content (e.g., the creative aspects of advertising), advertising vehicles (e.g., television-based advertising, print-based advertising, Internet-based advertising, etc.), and advertising campaign design (e.g., one or more combinations of different advertising vehicles and/or advertising content during particular time periods, seasons, etc.). However, in some examples the success or failure of marketing efforts relies on characteristics of the products and/or services.

Market analysts having large scale consumer databases are typically interested in identifying particular product characteristics (sometimes referred to herein as attributes) that are responsible and/or otherwise drive consumer purchase choices. Additionally, even when such characteristics are identified that illustrate and/or otherwise cause improved consumer purchase behavior, the market analysts are interested in identifying different levels of those characteristics. As used herein, a characteristic level refers to a sub-characteristic having relatively more granular detail of the characteristic. To illustrate, a flavor characteristic may include levels of vanilla, chocolate, strawberry, etc. A brand characteristic may include levels of brand “A,” brand “B,” etc. Examples disclosed herein discuss characteristics having 2-level variables (sub-characteristics), such as a flavor characteristic including only vanilla or chocolate. While examples disclosed herein refer to 2-level variables, examples are not limited thereto. In particular, and as disclosed below, characteristics having more than two levels may be analyzed using multinomial techniques in a similar manner as 2-level binomial variables.

Existing techniques to identify attribute importance rely on consumer choice models, such as Logit models, Probit models, Tobit models, etc., which are computationally cumbersome and/or otherwise time consuming. In such consumer choice models, the choice data is too sparse such that individual consumer level information at a household granularity is not available. For example, standard choice models used for circumstances where a consumer has a single purchase in one category (e.g., brand “X” for a chocolate flavored 16 ounce product) cannot determine an importance metric associated with that brand, size or flavor.

Examples disclosed herein estimate consumer level characteristic importance metrics from (a) consumer purchase data sources (e.g., a purchase dataset including consumer identifier information, product identifier information (e.g., UPCs), purchase date information, etc.) and (b) product attribute data sources (e.g., product identifier information (e.g., UPCs), characteristics (e.g., flavor, brand, etc.), characteristic levels (e.g., vanilla, chocolate, etc.). Examples disclosed herein employ a binomial likelihood function (BLF) for circumstances where characteristics of a product of interest have two levels (2-level characteristics, such as flavor having vanilla and chocolate as corresponding discrete levels/sub-characteristics). Equation 1 represents an example BLF.

$$B = ( \frac{N !}{x ! ( N - x ) !} ) {P}^{x} {( 1 - P )}^{( N - x )} . \qquad Equation 1$$

In the illustrated example of Equation 1, B refers to a binomial likelihood value, N refers to a number of purchases (e.g., for a particular category), x refers to a number of purchases of the characteristic level, and P refers to a prior probability of the characteristic level x. Equation 2 represents a generalized (e.g., non-integer) form of example Equation 1.

$$B = \frac{Γ ( N + 1 )}{Γ ( x + 1 ) Γ ( N - x + 1 )} {{P}^{x} ( 1 - P )}^{( N - x )} . \qquad Equation 2$$

Additionally, example Equation 3 represents the example binomial likelihood function in a logarithmic form that, in some examples, reduces a degree of computational complexity when determining the likelihood B.

ln(B)=lnΓ(N+1)−lnΓ(x+1)−lnΓ(N−x+1)+xlnP+(N−x)ln(1−P) Equation 3.

In some examples, a multinomial likelihood function (MLF) is employed for circumstances where characteristics of a product of interest have more than two levels (e.g., 3-level characteristics, such as flavor having chocolate, vanilla and strawberry). Equation 4 represents an example MLF.

$$M = \frac{Γ ( N + 1 )}{{\prod }_{i = 1}^{k} Γ ( {x}_{i} + 1 )} {\prod }_{i = 1}^{k} {P}^{{x}_{i}} . \qquad Equation 4$$

In the illustrated example of Equation 4, M refers to a multinomial likelihood value, N refers to a number of purchases (e.g., for a particular category), xᵢ refers to a number of purchases of the i^{th} characteristic level, k represents the number of levels for the characteristic (attribute) of interest, and P refers to a prior probability of the characteristic level xᵢ.

Examples disclosed herein consider temporal influences of retrieved and/or otherwise received purchase information. Purchase sequence and/or timing is considered to, for example, give more weight to relatively recent purchases. Such considerations are not applied for traditional analysis approaches, such as regression-based choice models.

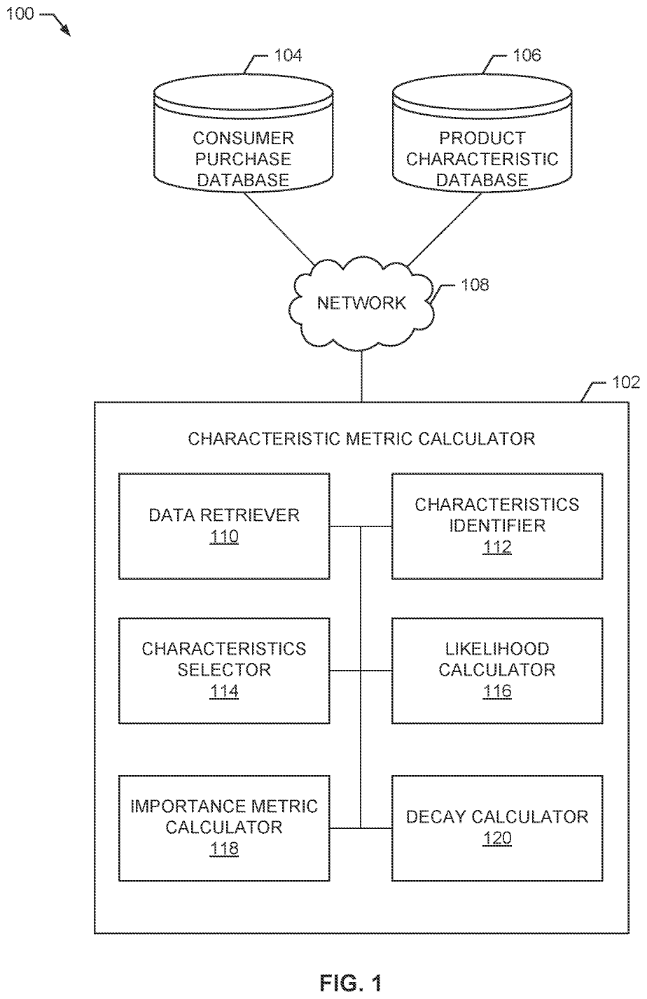

FIG. 1 is a schematic illustration of an example characteristics analysis system 100 that includes an example characteristic metric calculator 102. The example characteristic metric calculator 102 is communicatively connected to an example consumer purchase database 104 and an example product characteristic database 106 via an example network 108. The example characteristic metric calculator 102 includes an example data retriever 110, an example characteristics identifier 112, an example characteristics selector 114, an example likelihood calculator 116, an example importance metric calculator 118, and an example decay calculator 120.

The example consumer purchase database 104 stores consumer purchase data. For example, the consumer purchase database 104 stores purchase data of households. In some examples, the consumer purchase data includes consumer identifier data (e.g., a household identifier), product identifier data, and/or purchase date data. For example, the consumer purchase database 104 can store a first entry corresponding to a first product ID of a first product purchased by a first household on a first date, a second entry corresponding to a second product ID of a second product purchased by a second household on a second date, etc.

The example product characteristic database 106 stores product characteristic data. For example, the product characteristic data includes product identifier data, characteristic data (sometimes referred to herein as attribute data), and/or characteristic level data (sometimes referred to herein as attribute level data). In some examples, the product characteristic database 106 can store the number of characteristics and/or characteristic levels corresponding to a product. For example, the product can be a beverage with two possible brands (e.g., Brand X and Brand Y) and three possible flavors (e.g., Chocolate, Vanilla, and Strawberry). The example product characteristic database 106 stores two characteristics (e.g., brand and flavor) and the corresponding characteristic levels (e.g., Brand X, Brand Y, Chocolate, Vanilla, and Strawberry).

The example network 108 facilitates communication between the consumer purchase database 104, the product characteristic database 106, and/or the characteristic metric calculator 102. In some examples, any number of the consumer purchase database 104 and/or the product characteristic database 106 can be communicatively coupled to the characteristic metric calculator 102 via the network 108. The communication provided by the network 108 can be via, for example, the Internet, an Ethernet connection, USB cable, etc.

In operation, the example data retriever 110 acquires household purchase data, such as the above-identified types of (a) consumer purchase data from the example consumer purchase database 104 and (b) product attribute data from the example product characteristic database 106. In some examples, the data retriever 110 includes means for accessing data (sometimes referred to herein as data accessing means). The example means for accessing data is hardware. In some examples, the data retriever 110 accesses the consumer purchase database 104 and/or the product characteristic database 106 content in response to a query, on a manual basis, on a periodic basis, or on a scheduled basis. For example, the data retriever 110 may access the consumer purchase database 104 and/or the product characteristic database 106 once a month, once a quarter, once a year, etc. to determine product characteristics. In some examples, the data retriever 110 harmonizes, normalizes, and/or otherwise formats the data accessed from the consumer purchase database 104 and/or the product characteristic database 106. For example, the data retriever 110 deduplicates the data obtained from the consumer purchase database 104 and/or the product characteristic database 106.

The example characteristics identifier 112 identifies one or more characteristics of interest from the data sources based on whether such characteristics are of a binomial type (e.g., 2-level characteristics) or of a multinomial type (e.g., 3 or more characteristic levels). In some examples, the characteristics identifier 112 includes means for identifying characteristics (sometimes referred to herein as characteristics identifying means). The example means for identifying characteristics is hardware. In some examples, the characteristic identifier 112 determines the number of characteristic levels based on data stored in the product characteristic database 106. For example, the characteristic identifier 112 determines a product is associated with binomial characteristics (e.g., 2-level characteristics). Thus, the characteristic metric calculator 102 determines importance metrics of the characteristics using a BLF. Additionally or alternatively, the characteristic identifier 112 determines the product is associated with multinomial characteristics (e.g., the product has 3-level characteristics, 4-level characteristics, etc.). Thus, the characteristic metric calculator 102 determines importance metrics of the characteristics using an MLF. As used herein, an importance metric indicates a relative amount a household is attracted to or avoids a characteristic level of a purchase. In some examples, the importance metric is a value between −1 and 1. For example, if a characteristic level has a negative importance metric, the characteristic metric calculator 102 determines the household avoids the characteristic level. Similarly, if a characteristic level has a positive importance metric, the characteristic metric calculator 102 determines the household is attracted to the characteristic level.

The example characteristic selector 114 selects characteristics of interest and corresponding purchase data. For example, the characteristic selector 114 selects a characteristic of interest (e.g., brand, flavor, size, etc.) from the product characteristic data. In some examples, the characteristic selector 114 includes means for selecting characteristics (sometimes referred to herein as characteristics selecting means). The example means for selecting characteristics is hardware. The characteristic selector 114 identifies and obtains the consumer purchase data associated with the selected characteristic of interest. For example, the characteristic selector 114 selects “Brand X” as the characteristic of interest and obtains consumer purchase data including products of Brand X.

The example likelihood calculator 116 calculates a likelihood of purchases corresponding to characteristic levels of a characteristic (e.g., B for binomial characteristics, M for multinomial characteristics). In some examples, the likelihood calculator 116 includes means for calculating a likelihood (sometimes referred to herein as likelihood calculating means). The example means for calculating a likelihood is hardware. For example, the likelihood calculator 116 determines a likelihood of a first level. As described above, the first level (e.g., sub-characteristic) of a characteristic such as flavor could be, for example, Vanilla. Additionally, the example likelihood calculator 116 calculates a likelihood of a second level such as, for example, Chocolate. In some examples, the characteristic is a binomial characteristic. Thus, the likelihood calculator 116 determines a likelihood of purchases corresponding to the characteristic levels (e.g., B) using example Equations 1, 2, and/or 3. Additionally or alternatively, the characteristic is a multinomial characteristic. In such examples, the likelihood calculator 116 determines the likelihood of purchases corresponding to the characteristic levels (e.g., M) using example Equation 4.

If the characteristic is a binomial characteristic, the example likelihood calculator 116 calculates a maximum possible likelihood value, B*. Additionally or alternatively, if the characteristic is a multinomial characteristic, the example likelihood calculator 116 calculates a maximum possible likelihood value, M*. In some examples, the maximum possible likelihood value is calculated by taking the first derivative of example Equation 1 and/or Equation 4 and solving for a maximum value (which can further be determined as a local maximum/minimum by taking the second derivative thereof).

The example importance metric calculator 118 determines an importance metric for an attribute. In some examples, the importance metric calculator 118 includes means for calculating an importance metric (sometimes referred to herein as importance metric calculating means). The example means for calculating an importance metric is hardware. For example, the importance metric calculator 118 determines the importance metric for the attribute based on the representative likelihood B and the maximum possible likelihood value B*. In examples disclosed herein, if the characteristic is a binomial characteristic, the importance metric calculator 118 determines the importance metric in a manner consistent with example Equation 5.

$$Importance Metric = 1 - \frac{B}{{B}^{*}} \qquad Equation 5$$

In examples disclosed herein, the importance metric of a binomial characteristic is a value between −1 (e.g., avoidance) and 1 (e.g., attraction). For example, if the importance metric calculator 118 determines a negative importance metric value, the household is associated with avoiding the corresponding characteristic level (e.g., a higher likelihood of not purchasing a product of the characteristic level). Likewise, if the importance metric calculator 118 determines a positive importance metric value, the household is associated with being attracted to the corresponding characteristic level (e.g., a higher likelihood of purchasing a product of the characteristic level).

In some examples, if the characteristic is a multinomial characteristic, the importance metric calculator 118 determines the importance metric in a manner consistent with example Equation 6.

$$Importance Metric = 1 - \frac{M}{{M}^{*}} \qquad Equation 6$$

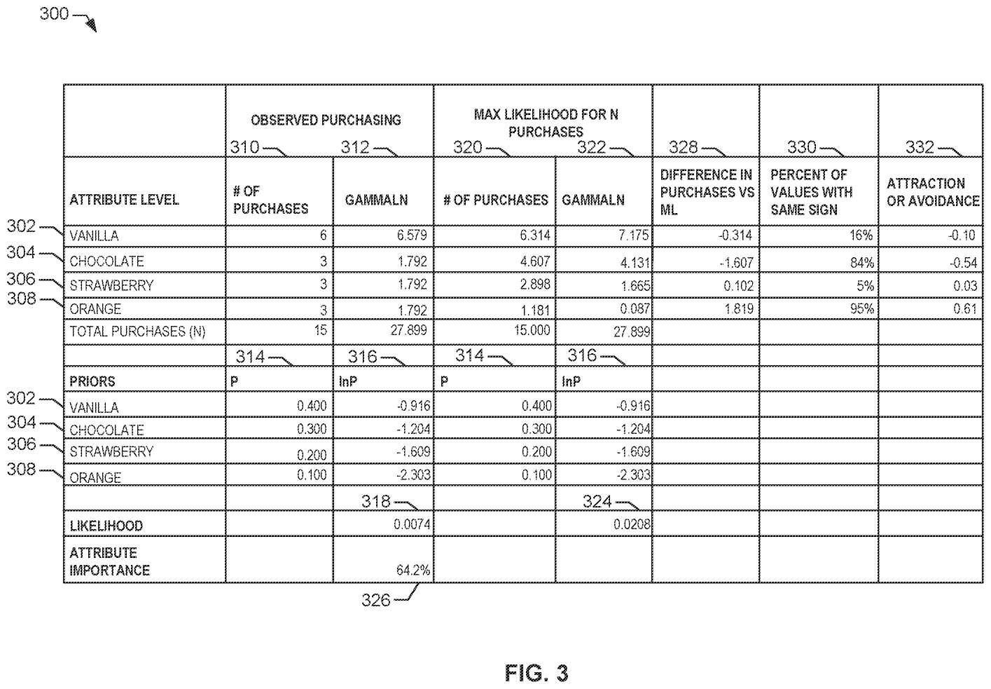

In contrast to the binomial importance metric (e.g., the importance metric of a binomial characteristic), the multinomial importance metric does not only indicate avoidance or attraction. For example, a consumer can be attracted to and/or avoid more than one level of the characteristic. For example, the characteristic can be flavor with three characteristic levels corresponding to Vanilla, Chocolate, and Strawberry. A consumer can be attracted to Vanilla and Chocolate and avoid Strawberry, be attracted to Vanilla and avoid Chocolate and Strawberry, etc. Thus, the importance metric calculator 118 determines a decomposition of the importance metrics for the characteristic levels. An example weighted purchase dataset is described in further detail below in connection with FIG. 3.

Examples disclosed herein improve computational efficiency. For example, the importance metric calculator 118 determines importance metrics for binomial characteristics using example Equation 5 and multinomial characteristics using example Equation 6. Thus, examples disclosed herein determine importance metrics in a more efficient manner than traditional techniques of computationally intensive regression. For example, examples disclosed herein enable an efficient, real-time technique to identify, measure, and track consumer attribute preference within and between product categories.

For example, the data retriever 110 obtains the purchase data of a household including four purchases (e.g., N=4): UPC1, UPC2, UPC3, and UPC4. In some examples, UPC1 is (Brand X, Vanilla), UPC2 is (Brand X, Chocolate), UPC3 is (Brand Y, Vanilla), and UPC3 is (Brand Y, Chocolate). That is, the household made two Brand X purchases, two Brand Y purchases, two Vanilla purchases, and two Chocolate purchases. In some examples, the total overall unit market share (e.g., the prior probability) for Brand X is 60%, Brand Y is 40%, Vanilla is 80%, and Chocolate is 20%.

The example characteristics identifier 112 analyzes and/or otherwise parses the purchase data to detect (a) characteristics and (b) corresponding levels of the characteristics. In this example, the characteristics identifier 112 determines the characteristics of the consumer purchase data are of a binomial type. That is, each characteristic has two characteristic levels (e.g., Brand X and Brand Y, Vanilla and Chocolate). Thus, the likelihood calculator 116 determines attribute importance metrics based on example Equations 1-3. In some examples, the characteristics selector 114 selects the Brand X characteristic level. In such examples, x=2 (e.g., two purchases of Brand X) and P=0.6 (e.g., the prior probability of Brand X is 60%). Thus, the likelihood calculator 116 determines the likelihood of two Brand X purchases is 0.3456

$$( e . g . , B = ( \frac{4 !}{2 ! ( 4 - 2 ) !} ) {0.6}^{2} {( 1 - 0.6 )}^{( 4 - 2 )} = 0.3 \; 456 ) .$$

Additionally or alternatively, the characteristics selector 114 selects the Brand Y characteristic level. In such examples, x=2 (e.g., two purchases of Brand Y) and P=0.4 (e.g., the prior probability of Brand Y is 40%). Thus, the likelihood calculator 116 determines the likelihood of two Brand Y purchases is 0.3456

$$( e . g . , B = ( \frac{4 !}{2 ! ( 4 - 2 ) !} ) {0.4}^{2} {( 1 - 0.4 )}^{( 4 - 2 )} = 0.3 \; 456 ) .$$

The example likelihood calculator 116 determines, by taking the first derivative of example Equation 1 and solving for a maximum value, the maximum likelihood for N=4 and P=0.6 occurs at 2.51 purchases of Brand X and 1.49 purchases of Brand Y. Thus, the likelihood calculator 116 determines B*=0.3832. The example importance metric calculator 118 determines the brand importance in a manner consistent with example Equation 5. In such examples, the importance metric calculator 118 determines the importance metric is 0.098

$$( e . g . , 1 - \frac{0.3456}{0.3832} = 0.0 \; 98 ) .$$

That is, because the likelihood calculator 116 used the BLF, the importance metric calculator 118 determines the household has a 0.098 attraction to Brand Y (e.g., a −0.098 avoidance of Brand X). In comparison to the prior probabilities, the household purchase data shows a relatively higher than expected purchase of Brand Y and a relatively lower than expected purchase of Brand X. In some examples, a market analyst generates an attribute importance profile including the importance metric indicating the household has a relative attraction to Brand Y and a relative avoidance of Brand X.

Additionally or alternatively, the characteristics selector 114 selects the Vanilla characteristic level. In such examples, x=2 (e.g., two purchases of Vanilla) and P=0.8 (e.g., the prior probability of Vanilla is 80%). Thus, the likelihood calculator 116 determines the likelihood of two

Vanilla purchases is 0.1536

$$( e . g . , B = ( \frac{4 !}{2 ! ( 4 - 2 ) !} ) {0.8}^{2} {( 1 - 0.8 )}^{( 4 - 2 )} = 0.1536 ) .$$

Additionally or alternatively, the characteristics selector 114 selects the Chocolate characteristic level. In such examples, x=2 (e.g., two purchases of Chocolate) and P=0.2 (e.g., the prior probability of Chocolate is 20%). Thus, the likelihood calculator 116 determines the likelihood of two Chocolate purchases is 0.1536

$$( e . g . , B = ( \frac{4 !}{2 ! ( 4 - 2 ) !} ) {0.2}^{2} {( 1 - 0.2 )}^{( 4 - 2 )} = 0.1536 ) .$$

The example likelihood calculator 116 determines the maximum likelihood for (P=0.8, N=4) is 0.477 (e.g., B*=0.477), in which the most likely purchases is 3.53 Vanilla (e.g., 4−0.47=3.53) and 0.47 Chocolate. The example importance metric calculator 118 determines the importance metric of flavor is 0.678

$$( e . g . , 1 - \frac{0.1536}{0.477} = 0.678 ) .$$

That is, the importance metric calculator 118 determines the household has a 0.678 attraction to Chocolate (e.g., a −0.678 avoidance to Vanilla). Stated otherwise, the consumer purchase data of the household has a greater than expected number of Chocolate purchases. Thus, the characteristic metric calculator 102 generates an attribute importance profile of the characteristics including Brand X −0.098, Brand Y 0.098, Vanilla −0.678, Chocolate 0.678. In some examples, the market analysts use the attribute importance profile to recommend marketing adjustments. For example, the attribute importance profile can be used to adjust marketing campaigns (e.g., increase advertisements for Brand X, etc.), products stocked in a store (e.g., increase the amount of Chocolate products stocked, etc.), etc. Thus, examples disclosed herein reduce human discretion when analyzing characteristics of a product. For example, the attribute importance profile identifies characteristics that, if emphasized in a marketing campaign, could improve sales of the product. A market analyst identifies characteristics to emphasize based on the attribute importance profile instead of human discretion.

In general, an attribute's importance will be close to 0 if the household has relatively few purchases in the category or if the household purchases are close to the category average. For example, a first household may purchase 2 Brand X products and 2 Brand Y products and a second household may purchase 20 Brand X products and 20 Brand Y products. If the prior probability of Brand X is 0.6, the importance metric calculator 118 determines the second household has a relatively higher brand importance metric than the first household because there is more data (e.g., 20 compared to 2) that the purchases of the second household deviate from the expectation on brand (e.g., 0.6 probability). In some examples, the importance metric can quantify targeted advertising effectiveness. For example, the first household was not exposed to an advertisement for Brand Y but the second household was exposed to the advertisement. Thus, a market analyst can determine the advertisement was effective based on the importance metric (e.g., the second household deviated from the expectation).

Additionally or alternatively, the example importance metric calculator 118 determines a characteristic has a higher importance if the prior probabilities have a relatively large disparity. For example, a household may have 2 Brand X purchases and 2 Brand Y purchases. If the prior probability of Brand X is 0.6 and the prior probability of Brand Y is 0.4, the even distribution of purchases between the two brands does not result in a high brand importance metric. However, if the prior probability of Brand X is 0.8 and the prior probability of Brand Y is 0.2, the importance metric calculator 118 determines a relatively higher brand importance metric. That is, the household is attracted to Brand Y. Thus, techniques disclosed herein can identify households attracted to unusual characteristics (e.g., gluten free, vegetarian, etc.). For example, techniques disclosed herein identify households more likely to purchase products with unusual characteristics with respect to prior probabilities of the characteristic levels. In some examples, a market analyst identifies households for targeted advertisements associated with the unusual characteristics based on the importance metric.

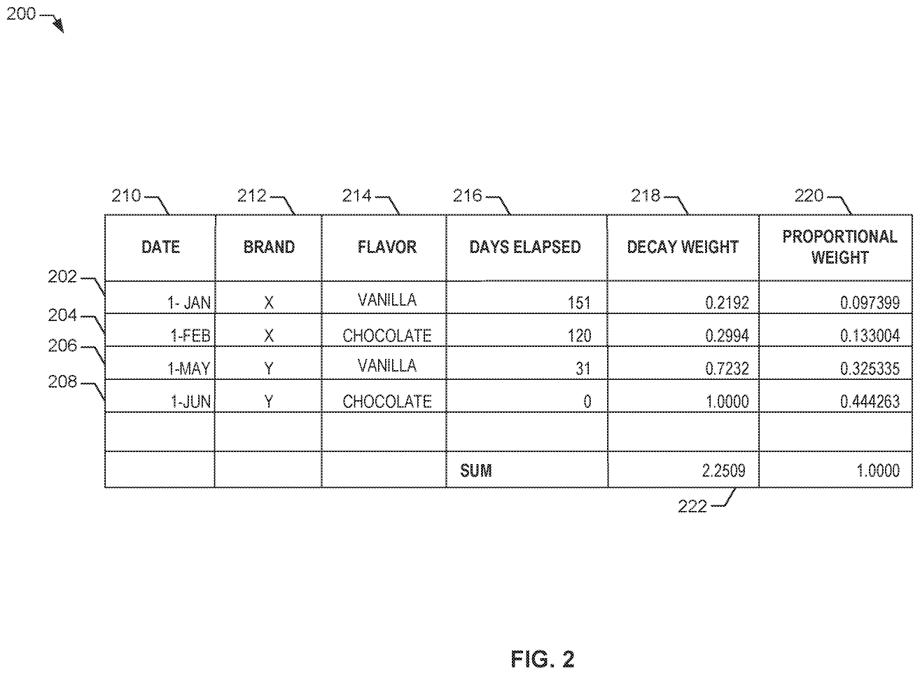

To consider the influence of purchase timing and/or sequence, the example decay calculator 120 applies one or more decay functions. In some examples, the decay calculator 120 includes means for temporally weighting data (sometimes referred to herein as temporally weighting data means). The example means for temporally weighting data is hardware. The example decay functions permit temporal weighting of the acquired data. Generally speaking, purchases that are relatively recent are weighted to a relatively higher degree than relatively older purchases. For example, if a household purchase history is Brand X, Brand X, Brand Y, Brand Y, the household may have switched from purchasing Brand X to purchasing Brand Y. Additionally or alternatively, if the household purchase history is vanilla, chocolate, vanilla, chocolate, the household may purchase flavor randomly. In some examples, the decay calculator 120 applies a daily decay function of 0.01, such that a purchase made one day earlier is weighted as 0.99 compared to the current day, a purchase made two days earlier is weighted as (0.99)² compared to the current day, etc. However, examples disclosed herein can use any suitable decay function. For example, the decay calculator 120 can apply a monthly decay function of 0.99, a daily decay function of 0.95, etc. An example weighted purchase dataset is described in further detail below in connection with FIG. 2.

FIG. 2 is a diagram representative of example household purchase data 200 corresponding to binomial characteristics. For example, the example purchase data 200 can be stored in the example consumer purchase database 104 (FIG. 1). The example household purchase data 200 includes an example first purchase 202, an example second purchase 204, an example third purchase 206, and an example fourth purchase 208. The example household purchase data 200 includes example date data 210, example first characteristic data 212, example second characteristic data 214, example days elapsed data 216, example decay weight data 218, and example proportional weight data 220. In the illustrated example of FIG. 2, the first characteristic data 212 is Brand and the second characteristic data 214 is Flavor. For example, the first purchase 202 occurred on January 1, was (Brand X, Vanilla), the second purchase 204 occurred on February 2, was (Brand X, Chocolate), etc.

The example decay calculator 120 (FIG. 1) determines the number of delays elapsed (e.g., the days elapsed data 216) for the purchases of the household. For example, the decay calculator 120 determines the number of days between the most recent purchase (e.g., the fourth purchase 208) and the remaining purchases of the household (e.g., the purchases 202, 204, 206). That is, the most recent purchase has 0 days elapsed. The example decay calculator 120 determines decay weight data 218. For example, the decay calculator 120 determines a decay weight for the purchases of the household based on the days elapsed data 216. In examples disclosed herein, the most recent purchase has a relatively greater weight than the least recent purchase (e.g., 1.0000 of the fourth purchase 208 is greater than 0.2192 of the first purchase 202).

In some examples, the decay calculator 120 determines proportional weight data 220. For example, the decay calculator 120 determines an example decay weight total 222. In the illustrated example of FIG. 2, the decay calculator 120 determines the decay weight total 222 is 2.2509 (e.g., 0.2192+0.2994+0.7232+1.0000˜2.2509). The example decay calculator 120 determines the proportional weight data 220 by dividing the decay weight data 218 by the decay weight total 222 (e.g., 0.2192/2.2509=0.097399, etc.). That is, the proportional weight data 220 for the purchases 202, 204, 206, 208 sums to 1.0000.

The example decay calculator 120 applies the proportional decay weight data 220 to the household purchase data 200. For example, as described above, the household bought two Brand X and two Brand Y. The decay calculator 120 adjusts the household purchase data based on the proportional decay weight data 220 to determine the household bought 0.92 Brand X products (e.g., (0.097399+0.133004)*4=0.92) and 3.08 Brand Y (e.g., (0.325335+0.444263)*4=3.08). In the illustrated example of FIG. 2, Brand Y has a relatively greater weight (e.g., number of purchases) than Brand X because of the temporal trend (Brand X, Brand X, Brand Y, Brand Y), as described above.

Similarly, the unweighted household data indicates the household bought two Vanilla products and two Chocolate products. The decay calculator 120 adjusts the household purchase data based on the proportional decay weight data 220 to determine the household bought 1.69 Vanilla products (e.g., (0.097399+0.325335)*4=1.69) and 2.31 Chocolate products (e.g., (0.133004+0.444263)*4=2.31).

Thus, the likelihood calculator 116 (FIG. 1) determines the likelihood of purchase based on the weighted data. For example, the number of Brand X purchases, x, changes from 2 to 0.92, the number of Brand Y purchases changes from 2 to 3.08, etc. The example importance metric calculator 118 determines the importance metric of Brand is 0.637 (compared to 0.098) and the importance metric of Flavor is 0.798 (compared to 0.678).

Additionally or alternatively, the decay calculator 120 adjusts the total number of purchases, N. For example, using the example decay weight data 218, the decay calculator 120 determines the household made 0.52 Brand X purchases (e.g., 0.2192+0.2994˜0.52), 1.73 Brand Y purchases (e.g., 0.7232+1.000˜1.73), 0.95 Vanilla purchases (e.g., 0.2192+0.7232˜0.95), and 1.3 Chocolate purchases (e.g., 0.2994+1.000˜1.3). Thus, the decay calculator 120 determines the household made 2.25 purchases (e.g., 0.52+1.73=0.95+1.3=2.25) instead of 4 purchases. The example importance metric calculator 118 determines the importance metric of Brand is 0.837 (compared to 0.098) and the importance metric of Flavor is 0.636 (compared to 0.678). In the illustrated example of FIG. 2, the importance metric of Brand changed relatively more than the importance metric of Flavor when weighted. This reflects the observed sequence (e.g., trend) of Brand compared to Flavor.

FIG. 3 is a diagram representative of example household purchase data 300 corresponding to multinomial characteristics. For example, the household purchase data 300 corresponds to the Flavor characteristic including an example Vanilla characteristic level 302, an example Chocolate characteristic level 304, an example Strawberry characteristic level 306, and an example Orange characteristic level 308. That is, the Flavor characteristic is a multinomial characteristic with four characteristic levels. For example, the household purchase data 300 includes example observed household purchase count data 310 (e.g., the number of purchases of characteristic level x) for the characteristic levels 302, 304, 306, 308.

The household purchase data 300 includes example first calculated data 312. For example, the first calculated data 312 is the Gamma function (e.g., (n)) of the natural log function (e.g., ln(n)) based on the observed household purchase count data 310. The example household purchase data 300 includes example prior probability data 314. For example, the Vanilla characteristic level 302 has a prior probability of 0.400, the Chocolate characteristic level 304 has a prior probability of 0.300, the Strawberry characteristic level 306 has a prior probability of 0.2000, and the Orange characteristic level 308 has a prior probability of 0.1000. The example household purchase data 300 includes example logarithmic probability data 316. For example, the likelihood calculator 116 (FIG. 1) determines the logarithmic probability data 316 based on the natural log of the prior probability data 314. For example, the likelihood calculator 116 determines the logarithmic probability data 316 of the Vanilla characteristic level 304 is −0.916 (e.g., ln(0.4000)=−0.916), the logarithmic probability data 316 of the Chocolate characteristic level 304 is −1.204 (e.g., ln(0.300)=−1.204), etc.

The example likelihood calculator 116 determines an example likelihood measure 318. For example, the likelihood calculator 116 uses example Equation 4 to determine the likelihood measure 318 based on the observed household purchase count data 310 and the prior probability data 314. In the illustrated example of FIG. 3, the likelihood measure 318 is 0.0074 (e.g., M=0.0074).

In the illustrated example of FIG. 3, the household purchase data 300 includes example maximum likelihood (ML) purchase count data 320. For example, the likelihood calculator 116 determines the ML purchase count data 320 using numeric maximization based on the total number of purchases (e.g., N=15) and the prior probability data 314. The household purchase data 300 includes example second calculated data 322. For example, the second calculated data 322 is the Gamma function (e.g., Γ(n)) of the natural log function (e.g., ln(n)) based on the ML purchase count data 320. The ML purchase count data 320 corresponds to an example maximum likelihood measure 324. In the illustrated example of FIG. 3, the maximum likelihood measure 324 is 0.0208 (e.g., M*=0.0208). That is, the maximum likelihood measure 324 occurs when the number of purchases (e.g., the ML purchase count data 320) of the characteristic levels 302, 304, 306, 308 are 6.314, 4.607, 2.898, and 1.181, respectively.

In the illustrated example of FIG. 3, the household purchase data 300 includes an example importance metric 326. For example, the importance metric calculator 118 (FIG. 1) uses example Equation 6 to determine the importance metric 326. The example importance metric 326 is approximately 64.2%

$$( e . g . , 1 - \frac{0.0074}{0.0208} \approx 0.6 \; 42 ) .$$

Thus, the Flavor characteristic has a 64.2% importance. However, because the Flavor characteristic in the illustrated example of FIG. 3 is a multinomial characteristic, the importance metric 326 does not indicate whether the household is attracted to or avoids the characteristic levels 302, 304, 306, 308. Thus, the importance metric calculator 118 determines a decomposition of the importance metric 326 to identify avoidance or attraction for the characteristic levels 302, 304, 306, 308.

In the illustrated example of FIG. 3, the household purchase data 300 includes example difference data 328. For example, the likelihood calculator 116 determines the difference data 328 based on the difference between the observed purchase count data 310 and the ML purchase count data 320. For example, the likelihood calculator 116 determines the difference data 328 of the Vanilla characteristic level 302 is −0.314 (e.g., 6−6.314=−0.314), the difference data 328 of the Chocolate characteristic level 304 is −1.607 (e.g., 3−4.607=−1.607), etc.

The example household purchase data 300 includes example sign data 330. For example, the sign data 330 indicates the percentage of values with the same sign (e.g., positive or negative).

The example household purchase data 300 includes example decomposition data 332. For example, the decomposition data 332 indicates an amount the household is attracted to or avoids the corresponding characteristic level. For example, the Vanilla characteristic level 302 has an attraction value of −0.10, the Chocolate characteristic level 304 has an attraction value of −0.54, the Strawberry characteristic level 306 has an attraction value of 0.03, and the Orange characteristic level 308 has an attraction value of 0.61. In examples disclosed herein, a negative value indicates a relative avoidance and a positive value indicates a relative attraction. In the illustrated example of FIG. 3, the household is most attracted to the Orange characteristic level 308 (e.g., the decomposition data 332 of the Orange characteristic level 308 is a positive value with the highest magnitude) and avoids the Chocolate characteristic level 304 (e.g., the decomposition data 332 of the Chocolate characteristic level 304 is the highest magnitude of the negative values). Thus, the example characteristic metric calculator 102 generates an attribute importance profile including the example decomposition data 332. In some examples, a market analyst adjusts marketing campaigns based on the attribute importance profile (e.g., increase advertisements for the Orange characteristic level 308, etc.).

While an example manner of implementing the example characteristics analysis system 100 and/or the example characteristic metric calculator 102 of FIG. 1 is illustrated in FIG. 1, one or more of the elements, processes and/or devices illustrated in FIG. 1 may be combined, divided, rearranged, omitted, eliminated and/or implemented in any other way. Further, the example data retriever 110, the example characteristics identifier 112, the example characteristics selector 114, the example likelihood calculator 116, the example importance metric calculator 118, the example decay calculator 120 and/or, more generally, the example characteristic metric calculator 102 of FIG. 1 may be implemented by hardware, software, firmware and/or any combination of hardware, software and/or firmware. Thus, for example, any of the example data retriever 110, the example characteristics identifier 112, the example characteristics selector 114, the example likelihood calculator 116, the example importance metric calculator 118, the example decay calculator 120 and/or, more generally, the example characteristic metric calculator 102 of FIG. 1 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data retriever 110, the example characteristics identifier 112, the example characteristics selector 114, the example likelihood calculator 116, the example importance metric calculator 118, the example decay calculator 120 and/or, more generally, the example characteristic metric calculator 102 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware. Further still, the example characteristic metric calculator 102 of FIG. 1 may include one or more elements, processes and/or devices in addition to, or instead of, those illustrated in FIG. 1, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

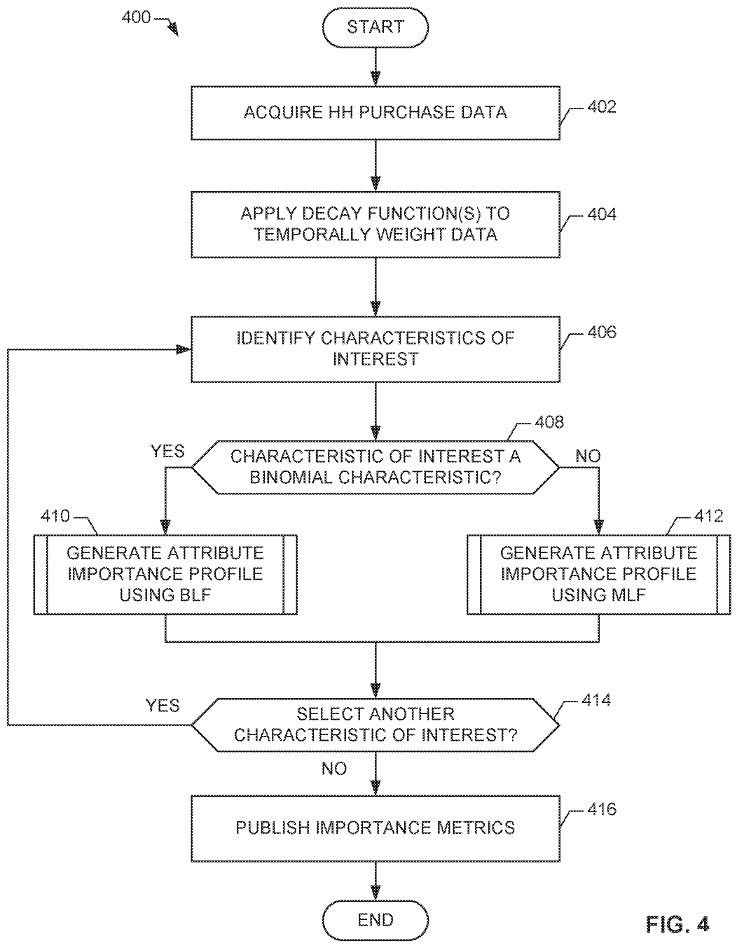

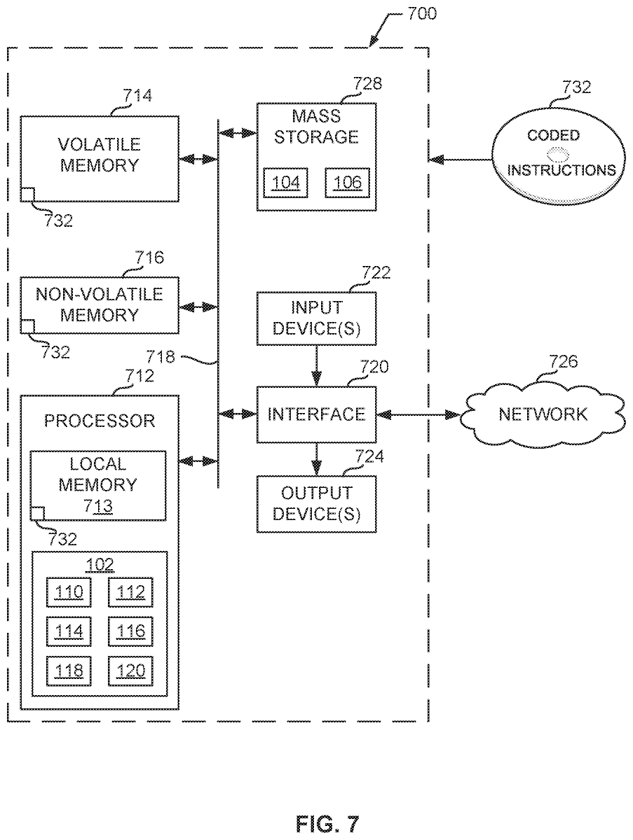

Flowcharts representative of example hardware logic, machine readable instructions, hardware implemented state machines, and/or any combination thereof for implementing the example characteristic metric calculator 102 of FIG. 1 are shown in FIGS. 4-6. The machine readable instructions may be one or more executable programs or portion(s) of an executable program for execution by a computer processor such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 4-6, many other methods of implementing the example characteristic metric calculator 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 2-3 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

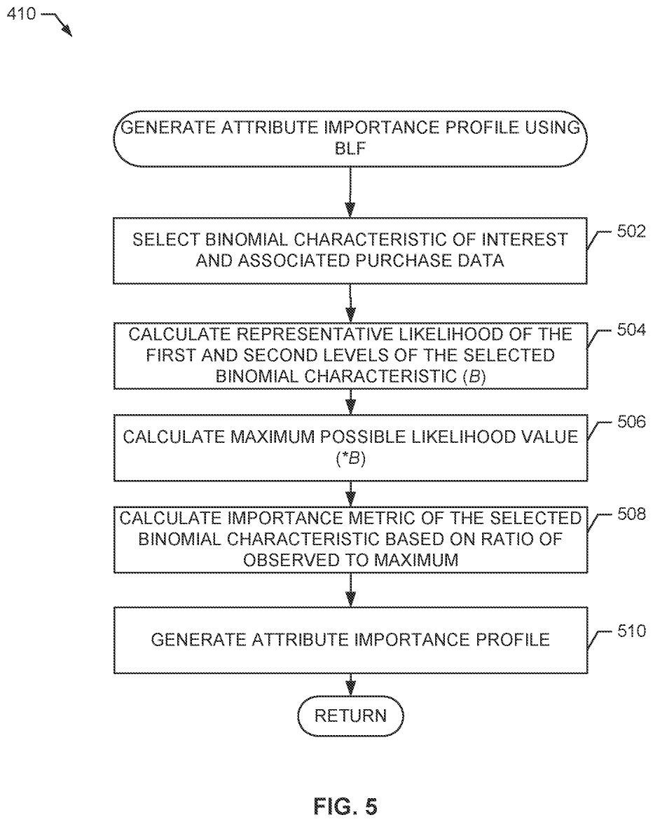

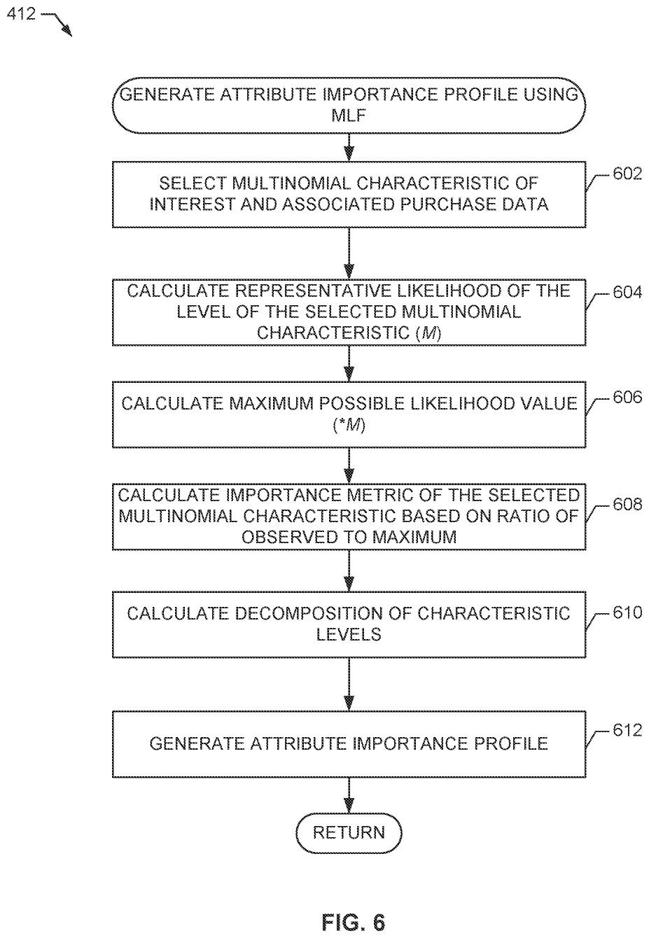

FIG. 4 is a flowchart 400 representative of example machine-readable instructions that may be executed to implement the example characteristic metric calculator 102 of FIG. 1. The example machine-readable instructions of FIG. 4 includes block 402, in which the example characteristic metric calculator 102 is invoked to generate attribute importance profile information. The illustrated examples of FIGS. 5-6 include additional details corresponding to generating such attribute importance information. In the illustrated example of FIG. 4, the example data retriever 110 (FIG. 1) acquires household purchase data (block 402). For example, the data retriever 110 obtains consumer purchase data stored in the consumer purchase database 104 (FIG. 1) and/or product characteristic data stored in the product characteristic database 106 (FIG. 1).

The example decay calculator 120 (FIG. 1) applies one or more decay functions to the acquired data to cause temporal weighting (block 404). For example, the decay calculator 120 applies a daily decay function of 0.01 to the acquired data. In some examples, the decay calculator 120 adjusts the number of purchases of characteristic levels based on the decay function.

The example characteristics identifier 112 (FIG. 1) identifies characteristics of interest (block 406). For example, the household purchase data can include the characteristics Flavor, Brand, Size, etc., and the characteristics identifier 112 identifies Flavor as the characteristic of interest. The example characteristics identifier 112 determines whether the characteristic of interest is a binomial characteristic (block 408). For example, the characteristics identifier 112 determines whether the number of characteristic levels of the characteristic of interest is greater than two. For example, the characteristics identifier 112 determines the Brand characteristic has two characteristic levels (e.g., Brand X and Brand Y), the Flavor characteristic has three characteristic levels (e.g., Vanilla, Chocolate, and Strawberry), etc.

If, at block 408, the example characteristics identifier 112 determines the characteristic of interest is a binomial characteristic, the example characteristic metric calculator 102 generates an attribute importance profile using a BLF (block 410). For example, the characteristic metric calculator 102 analyzes the household purchase data to determine an importance metric of the characteristic of interest using a BLF. Further example instructions that may be used to implement block 410 are described below in connection with FIG. 5.

If, at block 408, the example characteristics identifier 112 determines the characteristic of interest is not a binomial characteristic, the example characteristic metric calculator 102 generates an attribute importance profile using a MLF (block 412). For example, the characteristic metric calculator 102 analyzes the household purchase data to determine an importance metric of the characteristic of interest and a decomposition of the characteristic levels using an MLF. Further example instructions that may be used to implement block 412 are described below in connection with FIG. 6.

The example characteristics identifier 112 determines whether to select another characteristic of interest (block 414). For example, the characteristics identifier 112 determines whether a characteristic of the household purchase data has not been analyzed. If, at block 414, the characteristics identifier 112 determines to select another characteristic of interest, the program 400 returns to block 406. If, at block 414, the characteristics identifier 112 determines to not select another characteristic of interest, the example characteristic metric calculator 102 publishes the importance metrics and/or otherwise causes a marketing campaign adjustment in an effort to promote products that exhibit those characteristics that cause consumer purchase behaviors (block 416).

FIG. 5 is a flowchart 410 representative of example machine-readable instructions that may be executed to implement the example characteristic metric calculator 102 of FIG. 1. The example machine-readable instructions of FIG. 5 begin at block 502, at which the example characteristics selector 114 (FIG. 1) selects a binomial characteristic of interest and its corresponding purchase data. For example, if the characteristics identifier 112 (FIG. 1) selected Flavor as the characteristic of interest, the characteristics selector 114 selects the household purchase data corresponding to the Flavor characteristic.

The example likelihood calculator 116 (FIG. 1) calculates a representative likelihood value (B) corresponding to the first and second levels of the selected binomial characteristic (block 504). As disclosed above, such likelihood calculations may be conducted in a manner consistent with example Equation 1. For example, the likelihood calculator 116 determines the likelihood value based on the purchase data of the selected characteristic and the prior probabilities. The example likelihood calculator 116 calculates a maximum possible likelihood value (*B) (block 506). For example, the likelihood calculator 116 performs a numeric maximization on example Equation 1 to determine the number of purchases for the first and second characteristic levels corresponding to the maximum possible likelihood value.

The example importance metric calculator 118 (FIG. 1) calculates an importance metric of the selected binomial characteristic based on a ratio of the observed likelihood value to the maximum likelihood value (block 508). For example, the importance metric calculator 118 determines the importance metric in a manner consistent with example Equation 5. The example characteristic metric calculator 102 generates an attribute importance profile (block 510). For example, the attribute importance profile includes the likelihood value of the first and/or second characteristic levels and the importance metric. Control returns to the program 400 of FIG. 4.

FIG. 6 is a flowchart 412 representative of example machine-readable instructions that may be executed to implement the example characteristic metric calculator 102 of FIG. 1. The example machine-readable instructions of FIG. 6 begin at block 602, at which the example characteristics selector 114 (FIG. 1) selects a multinomial characteristic of interest and its corresponding purchase data. For example, if the characteristics identifier 112 (FIG. 1) selected Flavor as the characteristic of interest, the characteristics selector 114 selects the household purchase data corresponding to the Flavor characteristic.

The example likelihood calculator 116 (FIG. 1) calculates a representative likelihood value (M) corresponding to the characteristic levels of the selected multinomial characteristic (block 604). As disclosed above, such likelihood calculations may be conducted in a manner consistent with example Equation 4. For example, the likelihood calculator 116 determines the likelihood value based on the purchase data of the selected characteristic and the prior probabilities. The example likelihood calculator 116 calculates a maximum possible likelihood value (*M) (block 606). For example, the likelihood calculator 116 performs a numeric maximization on example Equation 4 to determine the number of purchases for the characteristic levels corresponding to the maximum possible likelihood value.

The example importance metric calculator 118 (FIG. 1) calculates an importance metric of the selected multinomial characteristic based on a ratio of the observed likelihood value to the maximum likelihood value (block 608). For example, the importance metric calculator 118 determines the importance metric in a manner consistent with example Equation 6. The example importance metric calculator 118 calculates a decomposition of characteristic levels (block 610). For example, the importance metric calculator 118 determines decomposition values of the characteristic levels indicating a relative attraction or avoidance to the characteristic level. The example characteristic metric calculator 102 generates an attribute importance profile (block 612). For example, the attribute importance profile includes the likelihood value of the characteristic levels, the importance metric of the characteristic of interest, and/or the decomposition of the characteristic levels. Control returns to the program 400 of FIG. 4.

FIG. 7 is a block diagram of an example processor platform 700 structured to execute the instructions of FIGS. 4-6 to implement the characteristic metric calculator 102 of FIG. 1. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a digital video recorder, a gaming console, a set top box, a headset or other wearable device, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example data retriever 110, the example characteristics identifier 112, the example characteristics selector 114, the example likelihood calculator 116, the example importance metric calculator 118, the example decay calculator 120 and the example characteristic metric calculator 102.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIGS. 4-6 may be stored in the mass storage device 728, in the volatile memory 714, in the non-volatile memory 716, and/or on a removable non-transitory computer readable storage medium such as a CD or DVD.

From the foregoing, it will be appreciated that example methods, systems, apparatus and articles of manufacture have been disclosed that eliminate erroneous analyst discretion when attempting to identify one or more characteristics of a product that, if bolstered, included and/or otherwise emphasized in a marketing campaign, will improve sales of that service and/or product. Additionally, example techniques disclosed herein to apply the example BLF and/or multinomial logit modeling in this manner allow such computational efforts to occur in a more efficient manner than traditional techniques of computationally intensive regression. The disclosed methods, apparatus and articles of manufacture improve the efficiency of using a computing device by avoiding such computationally intensive techniques, and allow for characteristic level determination even when consumer choice data is sparse. The disclosed methods, apparatus and articles of manufacture are accordingly directed to one or more improvement(s) in the functioning of a computer and further advance one or more improvements in the technical field of market research.

Example methods, apparatus, systems, and articles of manufacture to determine product characteristics corresponding to purchase behavior are disclosed herein. Further examples and combinations thereof include the following:

Example 1 includes an apparatus to generate characteristic metrics, the apparatus comprising a characteristics identifier to identify characteristics corresponding to purchase data, a characteristic selector to select one of the characteristics, a likelihood calculator to calculate a likelihood value of a first level of the selected one of the characteristics, and an importance metric calculator to reduce discretionary input of an analyst by calculating an importance metric based on a ratio of (a) the likelihood value of the first level and (b) a maximum likelihood value corresponding to the first level of the selected one of the characteristics.

Example 2 includes the apparatus as defined in example 1, wherein the characteristic identifier is to determine if the characteristic is a binomial characteristic.

Example 3 includes the apparatus as defined in example 2, wherein the likelihood value is a first likelihood value, and the likelihood calculator is to calculate a second likelihood value of a second level of the selected one of the characteristics.

Example 4 includes the apparatus as defined in example 1, wherein the characteristic identifier is to determine if the characteristic is a multinomial characteristic.

Example 5 includes the apparatus as defined in example 4, wherein the multinomial characteristic includes a first characteristic level, a second characteristic level, and a third characteristic level.

Example 6 includes the apparatus as defined in example 5, wherein the likelihood calculator is to determine a decomposition of the importance metric based on the first characteristic level, the second characteristic level, and the third characteristic level.

Example 7 includes the apparatus as defined in example 1, wherein the characteristics include at least one of a brand, a flavor, or a size.

Example 8 includes the apparatus as defined in example 1, further including a data retriever to access consumer purchase data and product attribute data.

Example 9 includes the apparatus as defined in example 8, wherein the consumer purchases data includes at least one of consumer identifier data, product identifier data, or purchase date data, and the product attribute data includes at least one of product identifier data, characteristic data, or characteristic level data.

Example 10 includes the apparatus as defined in example 8, further including a decay calculator to temporally weight the consumer purchase data and the product attribute data based on a daily decay function.

Example 11 includes the apparatus as defined in example 1, wherein the importance metric calculator is to generate an attribute importance profile based on the importance metric.

Example 12 includes a non-transitory computer readable medium comprising instructions that, when executed, cause at least one processor to, at least identify characteristics corresponding to purchase data, select one of the characteristics, calculate a likelihood value of a first level of the selected one of the characteristics, and reduce discretionary input of an analyst by calculating an importance metric based on a ratio of (a) the likelihood value of the first level and (b) a maximum likelihood value corresponding to the first level of the selected one of the characteristics.

Example 13 includes the non-transitory computer readable medium as defined in example 12, wherein the instructions, when executed, further cause the at least one processor to determine if the characteristic is a binomial characteristic.

Example 14 includes the non-transitory computer readable medium as defined in example 13, wherein the likelihood value is a first likelihood value, and the instructions, when executed, further cause the at least one processor to calculate a second likelihood value of a second level of the selected one of the characteristics.

Example 15 includes the non-transitory computer readable medium as defined in example 12, wherein the instructions, when executed, further cause the at least one processor to determine if the characteristic is a multinomial characteristic.

Example 16 includes the non-transitory computer readable medium as defined in example 15, wherein the multinomial characteristic includes a first characteristic level, a second characteristic level, and a third characteristic level.

Example 17 includes the non-transitory computer readable medium as defined in example 16, wherein the instructions, when executed, further cause the at least one processor to determine a decomposition of the importance metric based on the first characteristic level, the second characteristic level, and the third characteristic level.

Example 18 includes the non-transitory computer readable medium as defined in example 12, wherein the characteristics include at least one of a brand, a flavor, or a size.

Example 19 includes the non-transitory computer readable medium as defined in example 12, wherein the instructions, when executed, further cause the at least one processor to access consumer purchase data and product attribute data.

Example 20 includes the non-transitory computer readable medium as defined in example 19, wherein the consumer purchases data includes at least one of consumer identifier data, product identifier data, or purchase date data, and the product attribute data includes at least one of product identifier data, characteristic data, or characteristic level data.

Example 21 includes the non-transitory computer readable medium as defined in example 19, wherein the instructions, when executed, further cause the at least one processor to temporally weight the consumer purchase data and the product attribute data based on a daily decay function.

Example 22 includes the non-transitory computer readable medium as defined in example 12, wherein the instructions, when executed, further cause the at least one processor to generate an attribute importance profile based on the importance metric.

Example 23 includes an apparatus to generate characteristic metrics, the apparatus comprising means for identifying characteristics corresponding to purchase data, means for selecting one of the characteristics, means for calculating a likelihood value of a first level of the selected one of the characteristics, and means for calculating an importance metric to reduce discretionary input of an analyst by calculating the importance metric based on a ratio of (a) the likelihood value of the first level and (b) a maximum likelihood value corresponding to the first level of the selected one of the characteristics.

Example 24 includes the apparatus as defined in example 23, wherein the characteristics identifying means is to determine if the characteristic is a binomial characteristic.

Example 25 includes the apparatus as defined in example 24, wherein the likelihood value is a first likelihood value, and the likelihood calculating means is to calculate a second likelihood value of a second level of the selected one of the characteristics.

Example 26 includes the apparatus as defined in example 23, wherein the characteristics identifying means is to determine if the characteristic is a multinomial characteristic.

Example 27 includes the apparatus as defined in example 26, wherein the multinomial characteristic includes a first characteristic level, a second characteristic level, and a third characteristic level.

Example 28 includes the apparatus as defined in example 27, wherein the likelihood calculating means is to determine a decomposition of the importance metric based on the first characteristic level, the second characteristic level, and the third characteristic level.

Example 29 includes the apparatus as defined in example 23, wherein the characteristics include at least one of a brand, a flavor, or a size.

Example 30 includes the apparatus as defined in example 23, further including means for accessing data to access consumer purchase data and product attribute data.

Example 31 includes the apparatus as defined in example 30, wherein the consumer purchases data includes at least one of consumer identifier data, product identifier data, or purchase date data, and the product attribute data includes at least one of product identifier data, characteristic data, or characteristic level data.

Example 32 includes the apparatus as defined in example 30, further including means for temporally weighting data to temporally weight the consumer purchase data and the product attribute data based on a daily decay function.

Example 33 includes the apparatus as defined in example 23, wherein the importance metric calculating means is to generate an attribute importance profile based on the importance metric.

Example 34 includes a method to generate characteristic metrics, the method comprising identifying characteristics corresponding to purchase data, selecting one of the characteristics, calculating a likelihood value of a first level of the selected one of the characteristics, and reducing discretionary input of an analyst by calculating an importance metric based on a ratio of (a) the likelihood value of the first level and (b) a maximum likelihood value corresponding to the first level of the selected one of the characteristics.

Example 35 includes the method as defined in example 34, further including determining if the characteristic is a binomial characteristic.

Example 36 includes the method as defined in example 35, wherein the likelihood value is a first likelihood value, and further including calculating a second likelihood value of a second level of the selected one of the characteristics.

Example 37 includes the method as defined in example 34, further including determining if the characteristic is a multinomial characteristic.

Example 38 includes the method as defined in example 37, wherein the multinomial characteristic includes a first characteristic level, a second characteristic level, and a third characteristic level.

Example 39 includes the method as defined in example 38, further including determining a decomposition of the importance metric based on the first characteristic level, the second characteristic level, and the third characteristic level.

Example 40 includes the method as defined in example 34, wherein the characteristics include at least one of a brand, a flavor, or a size.

Example 41 includes the method as defined in example 34, further including accessing consumer purchase data and product attribute data.

Example 42 includes the method as defined in example 41, wherein the consumer purchases data includes at least one of consumer identifier data, product identifier data, or purchase date data, and the product attribute data includes at least one of product identifier data, characteristic data, or characteristic level data.

Example 43 includes the method as defined in example 41, further including temporally weighting the consumer purchase data and the product attribute data based on a daily decay function.

Example 44 includes the method as defined in example 34, further including generating an attribute importance profile based on the importance metric.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1-44. (canceled)

45. An apparatus to generate characteristic metrics, the apparatus comprising:
interface circuitry;
machine-readable instructions; and
at least one processor circuit to be programmed by the machine-readable instructions to:
obtain purchase data corresponding to a consumer identifier, the purchase data associated with a characteristic;
determine a number of levels associated with the characteristic;
calculate a first consumer level importance metric based on a first technique in response to determining the number of levels indicates that the characteristic is a binomial characteristic;
calculate a second consumer level importance metric based on a second technique in response to determining the number of levels indicates that the characteristic is a multinomial characteristic, the second technique different from a first technique; and
cause at least one of product stock increase or product stock decrease at a location based on the first consumer level importance metric or the second consumer level importance metric.

46. The apparatus of claim 45, wherein the binomial characteristic includes two levels and the multinomial characteristic includes at least three levels.

47. The apparatus of claim 45, wherein the purchase data corresponds to purchases of a product, wherein one or more of the at least one processor circuit is to determine the number of levels by determining a number of brands associated with the product. 48 (New) The apparatus of claim 45, wherein the consumer identifier corresponds to a household, wherein one or more of the at least one processor circuit is to cause the at least one of the product stock increase or the product stock decrease to the household based on the first consumer level importance metric or the second consumer level importance metric.

49. The apparatus of claim 45, wherein one or more of the at least one processor circuit is to cause the product stock decrease when the first consumer level importance metric or the second consumer level importance metric does not satisfy a threshold.

50. The apparatus of claim 45, wherein one or more of the at least one processor circuit is to cause the product stock increase when the first consumer level importance metric or the second consumer level importance metric satisfies a threshold.

51. The apparatus of claim 50, wherein the first consumer level importance metric or the second consumer level importance metric satisfies the threshold when the consumer level importance metric is greater than zero.

52. At least one non-transitory machine-readable medium comprising machine-readable instructions to cause at least one processor circuit to at least:
obtain purchase data corresponding to a consumer identifier, the purchase data associated with a characteristic;
determine a number of levels associated with the characteristic;
calculate a first consumer level importance metric based on a first technique in response to determining the number of levels indicates that the characteristic is a binomial characteristic;
calculate a second consumer level importance metric based on a second technique in response to determining the number of levels indicates that the characteristic is a multinomial characteristic, the second technique different from a first technique; and
cause at least one of product stock increase or product stock decrease at a location based on the first consumer level importance metric or the second consumer level importance metric.

53. The at least one non-transitory machine-readable medium of claim 52, wherein the binomial characteristic includes two levels and the multinomial characteristic includes at least three levels.

54. The at least one non-transitory machine-readable medium of claim 52, wherein the purchase data corresponds to purchases of a product, wherein the machine-readable instructions are to cause one or more of the at least one processor circuit to determine the number of levels by determining a number of brands associated with the product.

55. The at least one non-transitory machine-readable medium of claim 52, wherein the consumer identifier corresponds to a household, wherein the machine-readable instructions are to cause one or more of the at least one processor circuit to cause the at least one of the product stock increase or the product stock decrease to the household based on the first consumer level importance metric or the second consumer level importance metric.

56. The at least one non-transitory machine-readable medium of claim 52, wherein the machine-readable instructions are to cause one or more of the at least one processor circuit to cause the product stock decrease when the first consumer level importance metric or the second consumer level importance metric does not satisfy a threshold.

57. The at least one non-transitory machine-readable medium of claim 52, wherein the machine-readable instructions are to cause one or more of the at least one processor circuit to cause the product stock increase when the first consumer level importance metric or the second consumer level importance metric satisfies a threshold.

58. The at least one non-transitory machine-readable medium of claim 57, wherein the first consumer level importance metric or the second consumer level importance metric satisfies the threshold when the consumer level importance metric is greater than zero.

59. A method comprising:
obtaining, by at least one processor circuit programmed by at least one instruction, purchase data corresponding to a consumer identifier, the purchase data associated with a characteristic;
determining, by one or more of the at least one processor circuit, a number of levels associated with the characteristic;
calculating, by one or more of the at least one processor circuit, a first consumer level importance metric based on a first technique in response to determining the number of levels indicates that the characteristic is a binomial characteristic;
calculating, by one or more of the at least one processor circuit, a second consumer level importance metric based on a second technique in response to determining the number of levels indicates that the characteristic is a multinomial characteristic, the second technique different from a first technique; and
causing, by one or more of the at least one processor circuit, at least one of product stock increase or product stock decrease at a location based on the first consumer level importance metric or the second consumer level importance metric.

60. The method of claim 59, wherein the binomial characteristic includes two levels and the multinomial characteristic includes at least three levels.

61. The method of claim 59, wherein the consumer identifier corresponds to a household, further including causing the at least one of the product stock increase or the product stock decrease to the household based on the first consumer level importance metric or the second consumer level importance metric.

62. The method of claim 59, further including causing the product stock decrease when the first consumer level importance metric or the second consumer level importance metric does not satisfy a threshold.

63. The method of claim 59, further including causing the product stock increase when the first consumer level importance metric or the second consumer level importance metric satisfies a threshold.

64. The method of claim 63, wherein the first consumer level importance metric or the second consumer level importance metric satisfies the threshold when the consumer level importance metric is greater than zero.
